(19) United States
(12) Patent Application Publication
(10) Pub. No.: US 2010/0318806 A1
(43) Pub. Date: Dec. 16, 2010

(54) MULTI-FACTOR AUTHENTICATION WITH RECOVERY MECHANISMS

(76) Inventor: Dick Hardt, Vancouver (CA)

Correspondence Address: PERLEY-ROBERTSON, HILL & MCDOUGALL LLP, 1400-340 Albert Street, OTTAWA, ON, K1R 0A5, CA

(21) Appl. No.: 12/866,466

(22) PCT Filed: Feb. 9, 2009
(86) PCT No.: PCT/CA09/00157

§ 371 Date: Aug. 6, 2010

Related U.S. Application Data
(63) Continuation-in-part of application No. 61/027,235, filed on Feb. 8, 2008.

(51) Int. Cl. H04L 9/32; G06F 21/00

(52) U.S. Cl. 713/176; 726/19; 726/7; 713/168

(57) ABSTRACT

A single sign on facility provides redundancy and recovery functions through the use of a plurality of identifiers. Users prove identity to relying parties by demonstrating control over each of the plurality of identifiers. A user can employ a subset of the identifiers recognized by an RP to change an identifier that has been lost or which the user has lost control over.

### CROSS REFERENCE TO RELATED APPLICATIONS

This application claims the benefit of priority to U.S. Provisional Patent Application Ser. No. 61/027,235 filed Feb. 8, 2008 which is incorporated in its entirety herein by reference.

### FIELD OF THE INVENTION

This invention generally relates to mechanisms for administering login credentials in a single-sign on environment.

### BACKGROUND OF THE INVENTION

Conventional login systems for network resources and applications typically employ a username and password combination that is set during user registration. Recovery of a lost password is often performed using an out of band channel such as a confirmatory email message or through an alternate challenge such verification of alternate shared secrets such as a mother's maiden name or other such information. The user's email address and the other shared secrets are usually obtained (and possibly verified) during user registration.

To simplify the user experience and identity management, much attention has been paid to Single Sign On (SSO) systems. SSO systems relieve Relying Parties (RP) from username and password administration issues. User authentication is moved from the RP to an external authentication mechanism. Instead of requiring a user to authenticate at the RP, the RP requires that the user provide a credential from another system to prove that the user is the same entity that previously visited. The credential typically contains an identifier that allows the RP to associate the user with a local account. This system provides the user with the simplicity of managing a single credential set, and relieves the RP from various administrative burdens associated with user authentication.

However, the management of a single credential, such as through an identity provider, then becomes a single point of failure in a broader system.

In user centric identity management models, such as InfoCards and OpenID, a user is identified on the basis of being able to assert a credential that only the user is supposed to be able to provide. However, loss of the credential in these environments makes it difficult for a user to assert his identity to an RP in a manner that the RP will recognize and can verify, while a loss of control of the credential can leave the user powerless to regain control of his accounts at RP's.

It is, therefore, desirable to provide a single sign on facility that allows users to have redundancy and mechanisms to revoke an identity provider's authoritative status.

### SUMMARY OF THE INVENTION

It is an object of the present invention to obviate or mitigate at least one disadvantage of the prior art.

In a first aspect of the present invention, there is provided a method of authenticating a user at a relying party. The method comprises the steps of receiving a set of credentials; using a validation processor to execute stored instructions to validate each credential in the set of credentials; using a processor to execute stored instructions to determine that the set of credentials is associated with an existing user account; and authenticating the user as having access to the existing user account.

In an embodiment of the first aspect of the present invention, the step of receiving the set of credentials includes receiving the set of credentials from the user over a data network. In another embodiment, the step of receiving the set of credentials include receiving the set of credentials from an identity agent on behalf of the user over a data network.

In another embodiment of the first aspect of the present invention, the set of credentials includes a primary identifier and a set of associated universal resource identifier based identifiers. In another embodiment, the primary identifier includes a public portion of an authentication challenge, and optionally includes the public key from a public-private encryption key pair. In further embodiment, the step of using the processor to execute stored instructions to determine that the set of credentials is associated with an existing user account includes receiving a verification element associated with the received set of credentials; and determining that the verification element was generated using a private portion of the authentication challenge. In another embodiment, the primary identifier further includes a signature block generated with the private key. In a further embodiment, the primary identifier includes a verification universal resource locator, and the primary identifier includes a signature block that can be verified using the verification universal resource locator.

In a further embodiment, each identifier in the set of associated universal resource identifier based identifiers resolves to a unique identifier document. In other embodiments, each unique identifier document includes the primary identifier and references the universal resource identifier based identifiers in the set not associated with the identifier document, and the step of using a validation processor includes retrieving the unique identifier document associated with each identifier in the set of universal resource identifier based identifiers; and determining that each retrieved identifier document includes the primary identifier and references the universal resource identifier based identifiers in the set not associated with the identifier document.

In a further embodiment of the first aspect of the present invention, the step of authenticating the user includes determining that only a majority of the credentials in the set of credentials are associated with the user account. In a further embodiment, the method includes the step of updating that set of credentials associated with the user account to include all the credentials in the set of credentials.

In a second aspect of the present invention, there is provided a relying party for authenticating a user. The relying party comprises a login processor, a credential validation engine and a user login database. The login processor receives a set of credentials. The credential validation engine receives credentials from the set of credentials from the login processor, and validates the received credentials. The user login database stores credentials in association with a user account, and transmits user authentication verification to the login processor in response to receipt of validated credentials matching the stored credentials.

In a first embodiment of the second aspect of the present invention, the login processor includes means to update the user login database if a user account is associated with a majority of the credentials in the received set so that the user account is associated with all the credentials in the received set. In another embodiment of the second aspect of the present invention, the credential validation engine includes a cryptographic processor for determining that a verification element received in conjunction with the received set of credentials was generated by a private cryptographic key associated with a public cryptographic key contained in a Primary Identifier contained in the received set of credentials. In a further embodiment of the present invention, the credential validation engine includes a verification service interface for issuing a validation request to a verification service specified in a primary identifier contained in the received set of credentials. In a further embodiment, the login processor includes means to retrieve identifier documents associated with universal resource identifier based identifiers contained in the received set of credentials and the validation engine includes means to determine that a retrieved identifier document includes a primary identifier matching a primary identifier contained in the received set of credentials and a listing of universal resource identifiers associated with universal resource identifier based identifiers not associated with the retrieved identifier document and contained in the received set of credentials.

In a third aspect of the present invention, there is provided an identity agent for managing user identity credentials for submission to a relying party. The agent comprises a credential database and an identity selection engine. The credential database stores the user identity credentials. The identity selection engine receives a credential request from the relying party, requesting a set of user identity credentials from the credential database associated with the relying party, and transmits to the relying party a set of credentials received from the credential database in response to the request.

In embodiments of the third aspect of the present invention, the identity agent further includes a login database for associating the relying party to at least one set of credentials in the credential database and for providing the identity selection engine with an indication of which credentials in the credential database are associated with the relying party. In another embodiment, the login database associates the relying party to more than one set of credentials and the indication of which credentials are associated with the relying party includes indication that multiple sets of credentials are associated with the relying party, each set of credentials associated with a distinct persona. The identity selection engine can also optionally include a user interface for providing the user with a list of personas associated with a relying party, and for obtaining persona selection information from the user, and also include means for obtaining a set of credentials from the credential database selected in accordance with the obtained persona selection information.

Other aspects and features of the present invention will become apparent to those ordinarily skilled in the art upon review of the following description of specific embodiments of the invention in conjunction with the accompanying figures.

### DETAILED DESCRIPTION

The present invention is directed to single sign on authentication and identity management systems and redundancy obtained through the use of interlinked identifiers.

In the present invention, a user is identified to an RP using a set of credentials. These credentials are interlinked to so that a user can either lose one part of the set, or lose control of one part of the set, and still be able to assert identity information to the RP. After experiencing either loss or loss of control of a credential in the credential set, the user is able to recover the identity information by replacing the compromised credential.

Reference may be made below to specific elements, which are numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In the present invention, the user is identified at an RP by a set of identifiers that the user controls. Thus, the user is identified by the RP on the basis of control of a set of identifiers instead of on the basis of a credential issued by another organization. In the existing art, authentication relies upon a user being able to prove that he is the same entity that previously visited. User centric single sign on systems are employed to allow a Relying Party (RP) to delegate the user authentication to an external entity. The RP receives a credential associated with the user to validate that the user is the same entity that previously visited and registered. User centricity in identity management requires that the user controls aspects of the process. Typically this involves the user passing the credentials to the RP. In the user centric SSO system discussed below, the user maintains control over the identifier used by the RP to ensure authentication. One skilled in the art will appreciate that control over these identifiers is used as credentials by the user. Although, strictly speaking, the identifier itself is not a credential, through the following discussion the terms identifier and credential are used somewhat interchangeably as one skilled in the art will appreciate that in most instances the identifier is indistinguishable from the credential. This interchangeability is done for the sake of clarity.

In many user centric SSOs, loss of the identifier or loss of control of the identifier is catastrophic. It results in the loss of access to, and potential control over, accounts at any RP bound to the identifier. To address this issue, the present invention makes use of redundant identifiers that make reference to each other. Multiple identifier elements allow for recovery of accounts in the event of either a loss of, or loss of control over, one of the elements in the set. The RP can make use of mechanisms, as described below, to ensure that the user attempting to authenticate using an identifier has control over all identifiers in the list. Furthermore, authentication against a plurality of credentials can be used as authorization for the RP to remove an identifier from the list of approved identifiers. Mechanisms for these functions are discussed below.

In the present invention, the user is identified using a primary identifier and a set of URI identifiers. The URI identifier can be a universal resource locator (URL) that references an identifier document on a server, an extensible resource identifier (XRI) that references a document or another reference identifier as will be understood by those skilled in the art.

In the prior art, an RP relies upon an identity provider that exists in a federated or distributed identity management system, to provide a unique credential that is used to identity the user. As the identity provider has control over the credential, there is nothing for the user to lose control over other than the information used to authenticate with the identity provider. In user centric models, the login credential provided to an RP is managed by the user. The present invention makes use of user-controlled identifiers to provide an RP with sufficient information to determine that a particular user is the same user that visited previously. The system also provides a mechanism to recover from the loss or loss of control of an identifier.

In a system of the present invention, a user is identified at an RP by a primary identifier and at least two URI identifiers. To show that he is associated with one of the URI identifiers, the user proves that he has control over the identifiers by controlling the documents that the URI identifiers resolve to. One skilled in the art will appreciate that the format of the identifier documents that a URI identifier resolves to is preferably defined a priori. The Primary Identifier (PI) is a locally accessible credential that the user employs to prove control over the URI identifier. In some presently preferred embodiments, the PI can also be used to prove the integrity of the communication to the RP. When the user wishes to provide the RP with proof of identity, the PI and the set of URI identifiers are sent to the RP in a message. To provide the integrity of the communication, the PI can be used to generate either a signature block or another such verification element that can accompany the message. One skilled in the art will appreciate that where a verification element is generated using the PI, the combination of the PI and the verification element can be viewed as the credential, though once again, the following discussion with often refer to the PI alone as a credential (which in embodiments not having a verification element it is) for the sake of compactness.

The PI can be considered as the public portion of an authentication challenge with public and private portions. Each of the URI identifiers resolves to a document that contains the PI and a listing of the other associated URI identifiers. The user, in identifying himself to the RP, provides the PI, a set of URI identifiers, and optionally a datablock generated with the private portion of the authentication challenge. Because each of the URI identifiers in the set resolves to an identifier document that contains the PI and a listing of the other associated URI identifiers, the user has proved control over the URIs. The signed datablock can be verified with the public portion of the authentication challenge, contained in the PI, to determine both that the user is in possession of the private portion of the authentication challenge, and that the data as not been altered en route to the RP.

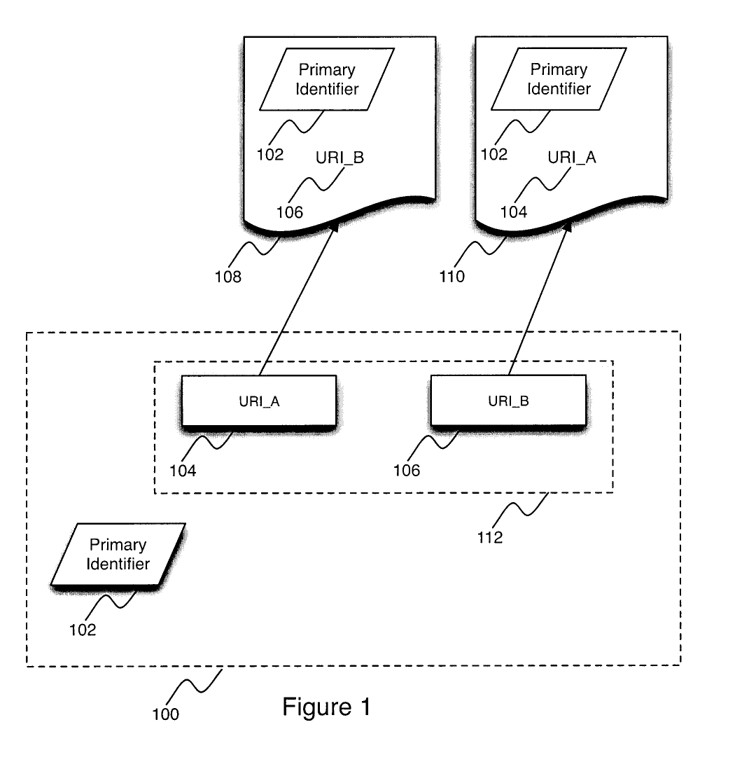

FIG. 1 illustrates a credential set 100 of the present invention. Three credentials form the set 100, the Primary Identifier 102, URI_A 104 and URI_B 106. URI_A 104 resolves to an identifier document referred to herein as Identifier_A 108, while URI_B 106 resolves to an identifier document referred to herein as Identifier_B 110. Identifier_A 108 contains PI 102 and URI_B 106, while Identifier_B 110 contains PI 102 and URI_A 104. Because the user includes the other URI and the PI in each identifier document, control over the URI associated with the identifier document is established. In a low security environment, the PI can be treated by the RP as a shared secret, and thus submission of the PI itself can be treated as control over the PI, in such an example, the PI is both the public and private portion of the authentication challenge. In a higher security environment, the private portion of the authentication challenge associated with the PI is used to generate a verification block that is transmitted along with the message to the RP. By using the PI, the verification block can be authenticated. Because the private portion of the authentication challenge is verified, control over the PI is asserted. One skilled in the art will appreciate that for simplicity of reference URI_A 104 and URI_B 106 can be referred to as a URI set 112.

In one embodiment the authentication challenge used to create the PI is a public-private cryptographic key. The public portion of the private-public key pair is stored in the PI, and in each of the URI identifier documents. The user uses the private key to sign the message containing PI and the URI identifiers. The signed block, which forms the verification element of the credential, can be verified by the RP as being signed by the private key associated with the public key in the PI. This provides proof that the data transmitted by the user has not been tampered with or corrupted in transmission, and shows that the user is in possession of the private portion of the authentication challenge and thus has control over the PI.

In another embodiment, the PI can be a verification URL (i.e. a verification service accessed through a specified URL). The user can connect to the verification service during the authentication operation and provide the PI and the URI set that will be used in the authentication process to the verification service. The service can authenticate the user, and then generate a token, such as a signed datablock that can be used to later verify a message. The user is then provided with the signed datablock, or token, to provide to the RP. When the RP attempts to validate the user, the identifiers are checked against the signed datablock by providing the verification URL specified by the PI with the signed datablock. The verification URL will respond with a message verifying the authentication of the user and verifying that the token or signed datablock was generated for the submission of the URI set. This allows the RP to establish both that the user has control over the private portion of the authentication challenge associated with the PI and that the message was not tampered with or corrupted in transit.

An example outlining the operation of a system using the present invention provides an opportunity to show how the system works. The following discussion refers to a PI stored locally for ease of explanation within the context of the exemplary embodiment.

The user registers with an RP and provides the PI, URI_A and URI_B. These three elements are used to identify the user. In the registration process, the RP verifies that identifier_A and identifier_B (located at the locations specified by URI_A and URI_B respectively) both contain the PI and that they make reference to each other. This verification process ensures that the user has control over the URI identifiers. The user also typically submits proof that he has control over the PI, typically in the form of a signed data block or token. The RP verifies that the user controls the PI by ensuring, during the verification process, that the signed data block and the PI are related. If the PI contains a portion of a cryptographic key pair, the RP verifies that the data block has been signed using the private key associated with the public key in the PI. If the PI contains a verification URL, the RP can provide the signed data block to the verification URL, and have the verification URL provide acknowledgement that the data block was issued and signed in conjunction with a particular set of URI.

When the user is finished registering, and revisits the RP, the RP is attempting to determine that the user presenting himself for login is, in fact, the same user that had previously visited and registered. The user provides the same identifiers that were used in the verification process (the PI and the set of URIs) and a signed datablock. Using at least two of the three identifiers, the user account can be retrieved and verified.

The system of the present invention provides the ability for a user to recover from either loss a portion of the credential set, or loss of control of one of the identifiers. The difference between the loss and loss of control can be shown as follows. If a user loses a private key associated with a PI, then the RP cannot perform verification on the message, and the user has effectively lost the identifier. If a third party obtains the private key, the third party can impersonate the user as the set of URIs are publicly accessible; this is characterized loss of control of the identifier. If the network server that hosts a URI identifier is taken offline, the user has lost the URI identifier. If a third party, such as the administration of the network server, modifies the identifier document that a URI identifier resolves to, there has been a loss of control. A loss of control of an identifier can result in a third party being able to impersonate the user. In prior art systems a loss of control often results in the third party being able to lock the user out of the account, thus loss of control over a credential can lead to loss of the credential. The present invention seeks to mitigate the damage caused by loss of control of identifiers.

If, continuing the example from above, the user loses an identifier, he can still be identified at the RP by the remaining two identifiers. The RP will be able to determine that an entity has two of the three identifiers that are associated with the user account, and can then invoke a recovery mechanism to allow replacement of the third identifier. One skilled in the art will appreciate that though reference here is made to a total of three identifiers, more than three identifiers can be used, and a simple majority of the identifiers can be used to identify the user. Two scenarios will now be presented; the first involves the loss of the PI, while the second involves the loss of a URI identifier.

In the first scenario, the user loses the private key associated with the PI, or alternatively, decides to change the service provider supplying the verification URL. The user has maintained control of both URI identifiers. A new PI is created, either through the creation of a new public-private key pair, or through the use of a new verification URL.

The user then modifies the documents identifier_A and identifier_B, which are obtained by resolving URI_A and URI_B respectively, to replace the previous PI with the new PI. The user then goes back to the RP and submits the new PI, URI_A, URI_B and the signed datablock. The RP recognizes the user because a majority of the credential set (URI_A and URI_B) is unchanged, though in this case the documents they resolve to have been changed. The RP also recognizes that a new PI has been submitted. The RP verifies that identifier_A and identifier_B have been modified to contain the new PI. Modification of identifier_A and identifier_B to include the new PI shows that the entity submitting the credentials has control over URI_A and URI_B and can thus be considered to be the user. A signed datablock sent along with the message shows that the user has control over the new PI, and thus is adding a new credential to the acceptable set of credentials (preferably to replace the existing credential known to the RP). Because the user has used two of the three credentials in the credential set, the RP can perform the same verification of the components outlined above, and then update the user profile to reflect the new PI. Thus the user is able to replace a PI, due either to loss, or loss of control.

In the second scenario, the user needs to replace one of the URI identifiers. The following example will show how URI_B is replaced although one skilled in the art will appreciate that URI_A can also be changed out using the same process. The user determines that URI_B should be removed as a valid identifier, due to loss or loss of control of the identifier, or due to other reasons determined by the user. The user obtains a new URI identifier, URIC. The user creates identifier_C, a document that both contains the PI and URI_A, and ensures that URI_C resolves to the location of identifier_C. The user then modifies identifier_A to remove the reference to URI_B and inserts a reference to URI_C. The user then provides the RP with PI, URI_A, URI_C and preferably a signed data block. The RP can identify the user based on the combination of PI and URI_A. The RP then verifies the set of credentials by retrieving identifier_A and determining that it contains the PI and references URI_C. The PI is then verified by checking the signed data block against the message and the PI. Successful verification of the two existing credentials, as well as the modification of identifier_A indicate to the RP that the user attempting to modify the stored identifiers is in control of two of the existing three credentials. As a result, the RP validates URI_C by examining identifier_C to determine that it properly includes the PI and references URI_A. When all the credentials are verified, the RP replaces URI_B with URI_C in the user profile stored in a user login database.

Thus, the user can replace any of the identifiers by demonstrating control over the majority of the identifiers. If a malicious third party is able to modify an identifier document at one of the URI identifiers, but does not have the ability to either control the PI or the other URI identifier, then the greatest damage that the third party can do is block the user from immediately logging into an RP. The user can then obtain a new URI identifier and change the credential set at the RP. If a malicious third party gains control over the PI (either by obtaining the private key or by obtaining access to the verification service), and knows the location of the URI identifiers, the user can be impersonated, and the third party can log into the RP, but cannot lock the user out of the account as access to identifier_A and identifier_B is not provided simply by knowing their location. However, it should be noted that although the URI identifiers resolve to identifier documents that can be publicly accessible documents, impersonation of the user requires that in addition to having control over the PI, the third party must determine what the URI identifiers are. The malicious third party would require control over two of the three identifiers in order to lock the user out of the account at the RP. Upon determining that he is being impersonated, the user can modify the identifier documents by inserting a new PI. This will prevent access to the RP by the malicious third party.

As a safety feature, it is presently preferable that the two URI identifiers are maintained by systems with different administrators so that a security breach at one of the systems does not compromise both URI identifiers and that the PI is managed by yet another system.

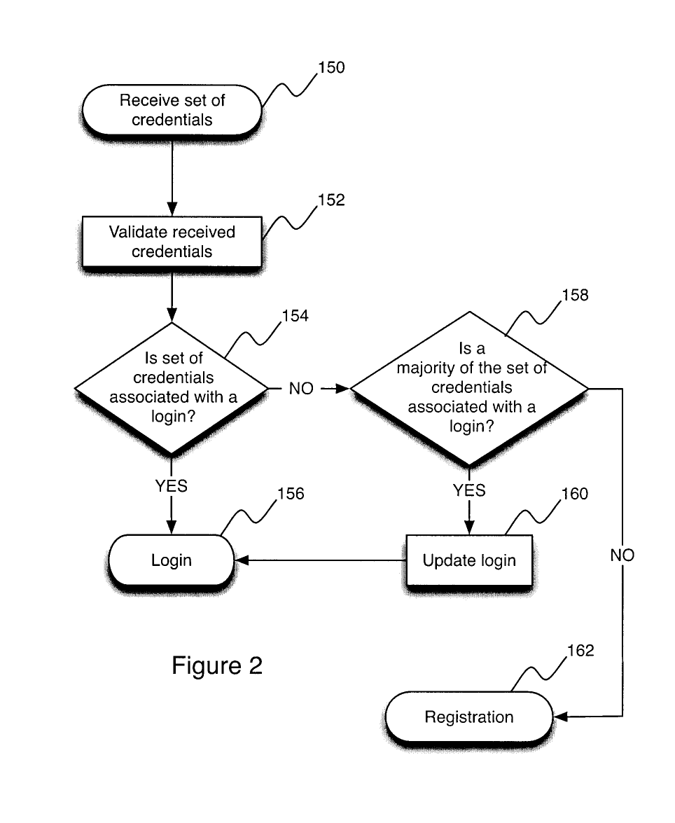

FIG. 2 illustrates a method of the present invention carried out by a relying party, as described above. In step 150, the relying party receives, through an interface to a data network, a set of credentials. In step 152, the credentials in the set of credentials are verified. Mechanisms and methods for verifying the credentials will be well known to those skilled in the art, and will be discussed in greater detail below. In step 154, a determination is made of whether or not the submitted credential set is associated with a known login. If the set of credentials match a known login, the relying party allows the user to login to the system in step 156. If the set of credentials do not match a known login in step 154, the process continues to step 158 where a determination is made of whether a majority of the credentials in the received set match a known login. If a majority of the verified credentials are associated with a known login, then the set of credentials associated with the known login is updated in step 160, and the user is logged into the system in step 156. If the majority of the credentials submitted does not match a known login in the determination of step 158, the system cannot determine which user account is attempting to login, and the user can be directed to a registration process in step 162. One skilled in the art will appreciate that in place of a registration process in step 162, a login failure can also be provided.

One skilled in the art will appreciate that the validation of the credentials in step 152 can be carried out either in the indicated spot in the process, or validation can be performed at other points prior to login at step 156. In one embodiment, validation of the credentials can be carried out after affirmative determinations at both steps 154 and 158. If registration of a user is performed in step 162, validation of the credentials should be performed as part of that process. If validation of the credentials fails, a failure message can be provided to the user.

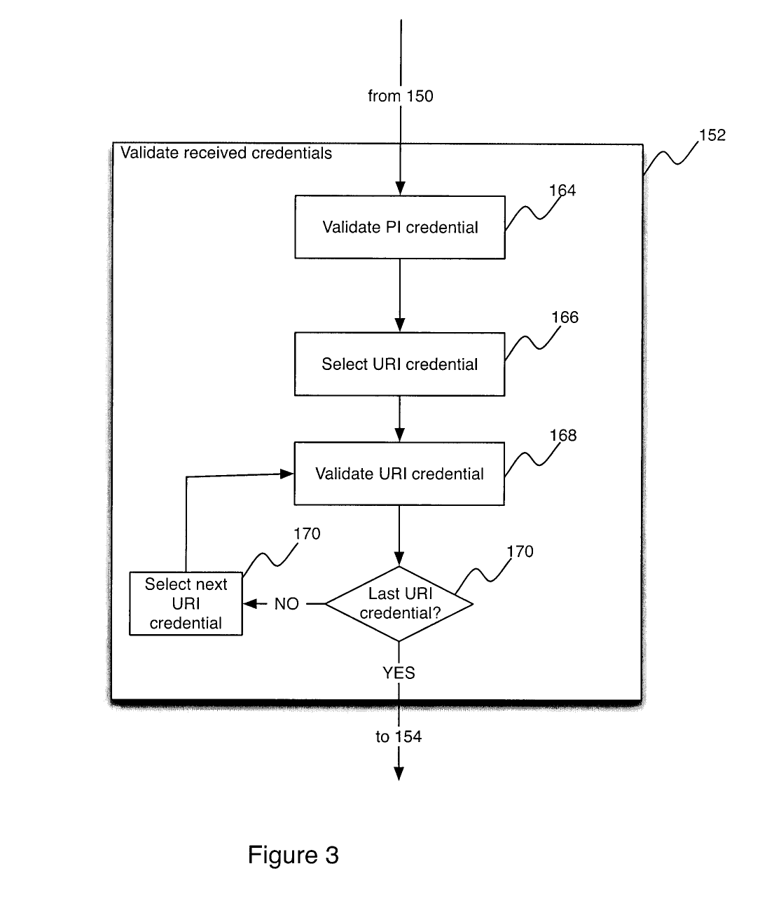

FIG. 3 illustrates an optional method for the validation of credentials in step 152. In step 164, the PI in the received credential is validated. If the PI itself is treated as a shared secret, then its presence is considered sufficient for validation. In the alternate, the PI can be validated as described above with respect to both the verification of the cryptographic key pair or the use of a verification URL. Upon successful validation of the PI, one of the URI credentials from the credential set is selected in step 166. The selected URI credential is validated in step 168 by determining if the document it resolves to contains the PI and the other submitted URI credential(s), as described above. In step 170, a determination is made of whether the selected URI credential is the final URI credential in the set of credentials. If it is not, the process continues to step 172 where the next URI credential is selected. Validation of each URI credential in the set of credentials can be performed in series, until the last URI credential has been validated, at which point, the process will continue to step 154.

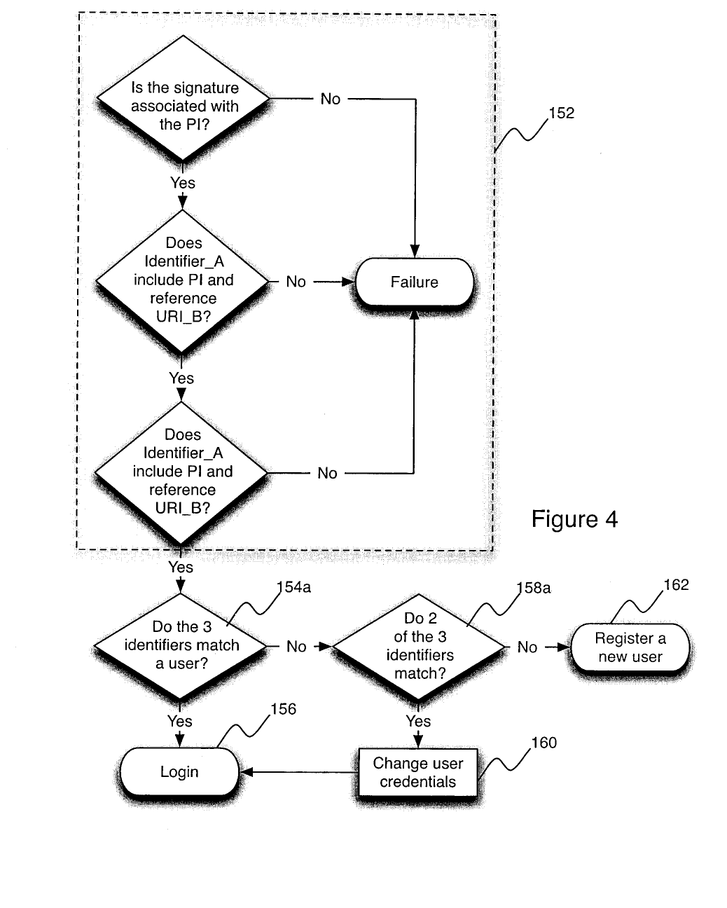

FIG. 4 illustrates an embodiment of the present invention in which only three credentials are provided. The set of credentials includes a PI, and URI identifiers URI_A and URI_B, which resolve to identifier_A and identifier_B respectively. After receiving the credentials, the RP validates the credentials in step 152. The validation includes, determining in step 174 if the received signature block is associated with the PI; determining in step 176 if identifier_A, the document associated with URI_A, includes the PI and references the final credential URI_B; and determining in step 178 of identifier_B, the document associated with URI_B, includes the PI and references the previously described credential URI_A. If any of these determinations fail, the process terminates at step 180 with a credential verification failure.

Upon validation of the credentials in step 152, a determination is made in step 154a of whether the three credentials match a known user login. If the three credentials match a known user login, the RP allows the user to login in step 156. In the alternate, a determination is made in step 158b to determine whether two of the three submitted credentials match a known login. If the determination of step 158b has an affirmative result, the credentials associated with the user login are changed in step 160, and the user is logged in in step 156. If, in step 158b, the determination is made in the negative, a new user can be registered in step 162.

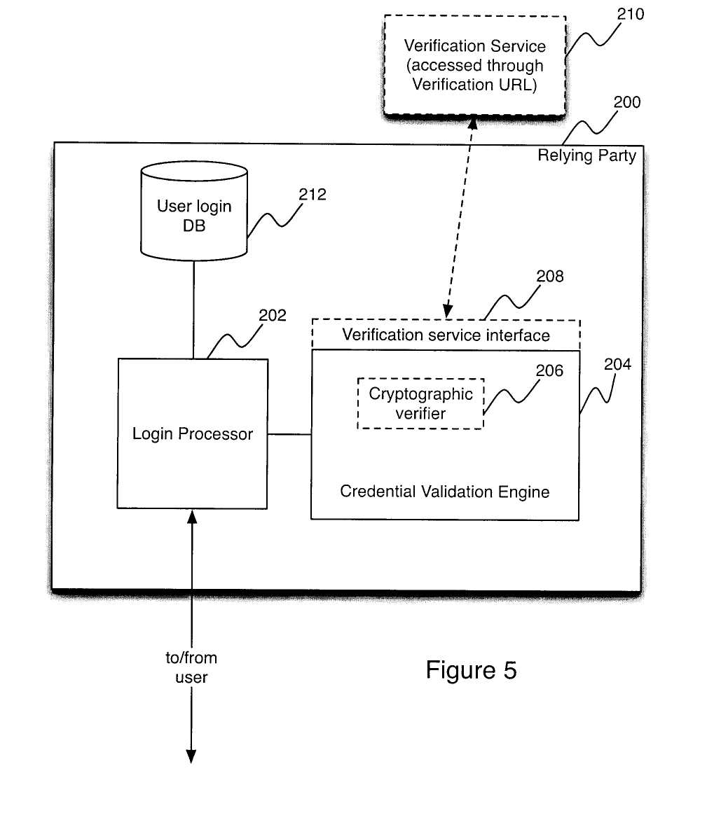

FIG. 5 illustrates an exemplary embodiment of a Relying Party 200 of the present invention. RP 200 interacts with a user (as illustrated), or another entity acting on behalf of the user, to receive login information. In the illustrated embodiment, RP 200 receives a set of credentials from a user as login information. Login processor 202 processes the received credentials, employing credential validation engine 204 to validate the credentials, and user login database 212 to match the credentials to known user login information. As described above with respect to the methods of FIGS. 2 and 4, login processor 202 receives the set of credentials from the user, and forwards the set to credential validation engine 204 to validate the credentials. Credential validation engine 204 validates the PI as described above, optionally using either cryptographic verifier 206 or verification service 210 accessed through verification service interface 208. Verification service 210 is accessed using a verification URL provided in the credential set as described above. The credentials in the set received by login processor can be checked against credentials in the user login database 212 to determine which user account is associated with the credentials. If required, the login processor can update the user account in database 212 to reflect the receipt of a new credential. One skilled in the art will appreciate that as described above, the order in which the validation of the credentials and the determination of the user account associated with the credential set is performed can vary in different implementations, and can be carried out in parallel if so desired. The logical elements described above can be implemented in a variety of different manners, including through the user of general purposed computing hardware provided with executable instructions to allow the above-described functionality. Elements such as the cryptographic verification engine 206 can also make use of specialized hardware designed for cryptographic operations, and elements such as the verification service interface 208 can be implemented in a combination of software on a general purposed computing platform and a network interface connected to a data network, such as the Internet, through with the verification service 210 can be accessed.

The management of the PI and URI identifiers can be performed by an identity agent, which operates on behalf of the user. The identity agent can be provided as a web browser plugin, an integrated element of the web browser, a component of the operating system, a standalone application, a webservice, a website or other mechanisms that will be well understood by those skilled in the art.

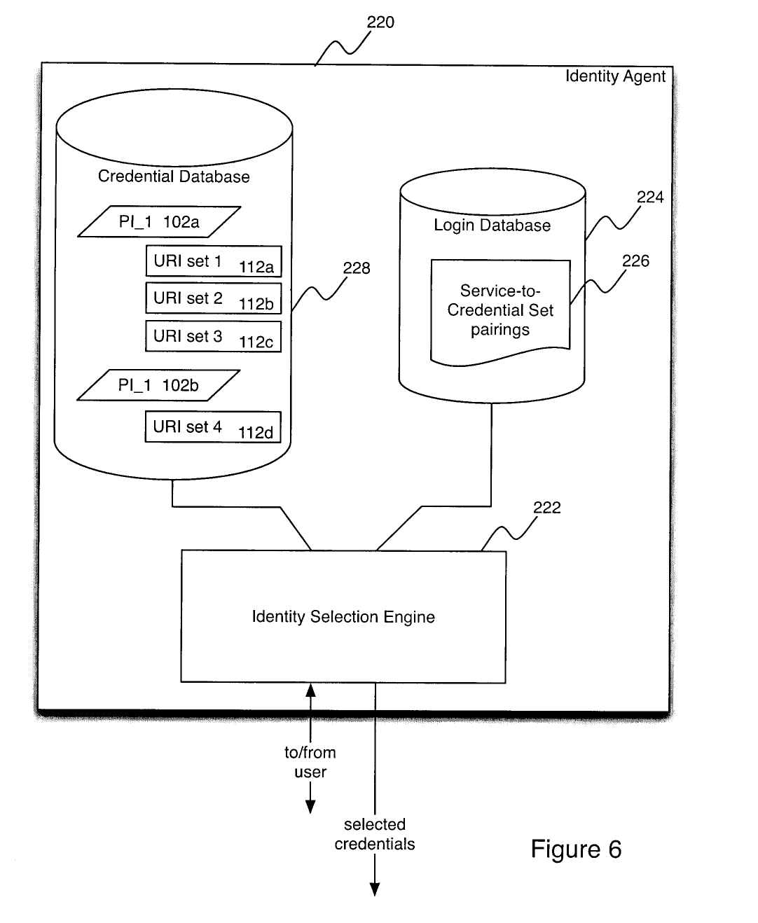

FIG. 6 illustrates an exemplary embodiment of an Identity Agent 220. The use of Identity Agent 220 can simplify the login process. When the RP issues a request for authentication, it typically makes use of an interface on a web page. The Identity agent 220 can detect either the request or the interface, using mechanisms such as detection of specific markup language. Upon detecting a login interface, the Identity Agent 220 can provide a login manager interface provide the user with a consistent login experience. To aid in preventing phishing attempts that target user identity information, the interface can be rendered with a user selectable elements to decrease the likelihood that a malicious RP can use a spoofed interface to collect data.

The login interface allows the user to interface with identity selection engine 222, which accesses login database 224, to determine which set of credentials is associated with the RP that has issued the request for credentials. In the illustrated embodiment, the request for credentials is logically provided to the identity agent 220 through the user, though one skilled in the art will appreciate that this detail can vary in different embodiments. Login database 224 stores pairings of RPs and sets of credentials 226. Each RP that requires a login has at least one entry in the login database, and is associated with a set of credentials that is used to login at that service. One skilled in the art will appreciate that different sets of credentials can be used at a single RP to create different logins. Because it is the overall set of credentials that identifies the user to the RP, there can be overlap between different sets of credentials. When multiple sets of credentials are associated with an RP, the user can be prompted by identity selection engine 222 to select a login, which is preferably indicated to the user in a user-friendly manner.

Often different accounts at an RP are used as different personas. In the present invention, personas are easily created by using differing sets of identifiers. One skilled in the art will appreciate that partial overlap in the use of identifiers (such as two sets sharing a PI but having different sets of URI identifiers) is possible, as the RP relies on submitting the full set of identifiers for login, and submitting the majority of identifiers for updating the remaining identifier(s). Personas can be managed by the Identity Agent 220 to simplify this process. The Agent 200 can use login database 222 to track which sets of identifiers have been submitted to an RP, and allow a user to pick between the identifier sets. The Identity agent 220 can store a default persona value for a particular RP in the login database 224, so that when the Identity agent 220 presents the user with a login manager interface, the default option is pre-selected, with an option to change the set of identifiers to use.

The sets of credentials are stored in credential database 228, which is access by identity selection engine 222 to retrieve the credential set determined by login database 224. Credential database 228 can store multiple primary identifiers, such as PI_1 102a and PI_2 102b, as well as a plurality of URI identifier pairs that are associated with a PI, such as URI set 1 112a, URI set 2 112b and URI set 3 112c which are all associated with PI_1 102a, and URI set 4 112d which is associated with PI_102b. Each set of credentials, composed of a URI set and the corresponding PI is a unique pairing of credentials that will identify the user to the RP. Different types of PI can be stored in the credential database 228, so that PI_1 102a could be a cryptographic key pairing, while PI_2 102b could be a verification URL.

The Identity agent 220 can store a user preference for a default set of identifiers from the plurality of credential sets associated with particular RPs. Preferably this preference is stored in login database 224. Upon identity selection engine 222 rendering the login interface in the webpage (or in a standalone window), the user can be provided with the various valid personas associated with the particular RP in a list, with the default persona at the top of the list. The Identity Agent 220 can also associate icons with each persona.

The Identity Agent 220 can also assist the user in creating a credential set specific for a given RP, a feature often called directed identity. When visiting a new RP, the Identity Agent 220 can generate a new, unique PI and issue calls to servers creating new URI identifiers. The new PI and URI identifiers form a new credential set that can be provided to the RP. Since none of the identifiers will have been used at any other RP, the user's privacy of visiting that RP is protected as that RP cannot correlate the identifiers with any other RP the user has visited.

During the login process, the identity agent 220 can obtain and store a logout URL from the RP. A user wishing to determine which RP's have active sessions can use the Identity Agent 220 to view the list of logout URLs. The Identity Agent 220 can provide the user with the ability to logout from any or all of the RP's with which there is an active session through the user of the stored logout URL(s). A button can be provided in the browser chrome to allow the user to access the logout command.

The Identity Agent 220 can also maintain a list of all RP's that use a particular URI or PI as an identifier. When the user determines that the URI or PI should be removed, the Identity Agent 220 can automate the update process with all RP's that use the PI or URI. Removing a PI or URI from the lists of URI's maintained at an RP is best done en masse because it requires that the user have control of the other identifiers known to the RP. If a user delays removing an identifier, as may occur if the user is manually updating the set of identifiers at each of a number of RP's, it is possible for a second identifier to be lost before the user visits a particular RP. In such a case, the user will be unable to retrieve the login as two of the three credentials will no longer be under the user's control. The Identity Agent 220 can also be used to update the identifier documents at each of the URI identifiers. When a user changes a PI, the Identity Agent 220 can automate the process of updating identifier documents that reference the PI, by determining which URI identifiers are associated with the PI in the credential database 228. If a user is changing a URI identifier, the Identity Agent can automate the modification of the remaining identifier document(s) to reference the new URI identifier, and can ensure that the new identifier document properly includes the PI and refers to the other associated URI identifier(s). For added safety, the servers hosting the identifier documents can authenticate the user, during this modification process, with some other method such as email verification, shared secrets, voice print etc., similar to how websites today verify the user if the user has lost their password.

It should be noted that a number of different protocols can be used to retrieve the identifier documents from the URI identifiers. If a URI references a file stored on a server, a protocol such as http can be employed, in such an example, the URI may resemble http://identity1.example.com/identifier_A.html. In other examples, the URI may be an XRI using a different, and possibly proprietary protocol. Other protocols, including secure protocols such as https can be used. In another example, the retrieval of an identifier document can be performed using DNS or DNS-SEC. In such an example, the URI could resemble URI_A.example.com. When the RP performs a DNS lookup on the address, instead of returning an IP address and path to a file, the DNS lookup can provide a TXT Record. This TXT record can contain the identifier document. Other DNS records types including Rdata, or types introduced in future revisions to the DNS standard could also provide another mechanism for retrieving an identifier document through the DNS protocols. The use of DNS provides a light weight mechanism for retrieving an identifier document compared to an HTTP request and upgrading to DNS-SEC increases the security afforded by the light weight DNS solution.

It should be noted that though the above described system makes use of three identifiers (a PI and two URI identifiers) as credentials, additional identifiers can be included. Varying levels of the number of credentials needed to replace credential in the set can be implemented to satisfy desired security levels. Thus, in one embodiment, a simple majority of the credentials are needed to replace the remaining identifiers, whereas in another embodiment, all identifiers (save for the one being replaced) are required to replace an identifier.

In a further embodiment, an identifier document found at a URI identifier, can contain more than one PI. This would allow a user to make use of one PI on one computer, and another PI on a second computer. The RP can either accept one of multiple registered PI's, or it can perform the credential change operation each time that the user changes the PI used. An identity agent managing a PI for a user, can change all credential sets at all registered RP's when it is started, to allow a user to seamlessly use multiple systems. Alternately RP's can accommodate two PI's for a single user. This allows a user to have a fixed set of URI identifiers and different PI's for each computer. This functionality is typically more important for locally stored PI's, as it is easier to ensure that two Identity Agents make use of a single verification URL than it is to ensure that they both have access to a single private cryptographic key.

Those skilled in the art will appreciate that although the automated change of credentials is discussed above when a portion of the set of credentials does not match, the change of credentials stored at an RP may require user approval. Thus, when a user creates a new credential, such as a new URI identifier or a new PI, an identity agent may prompt the user to approve the change of credentials at each RP. This can be done to accommodate RP requirements for user approval to changes of the user account profile. Similarly, an RP may accommodate a reset function for the credentials of a user to allow a user to initiate a reset of the credentials associated with the user account. This allows a user who has lost a majority of the credentials, or all the credentials, to still access the user account at an RP. Typically this reset function will require the user to provide some other proof of access rights, such as knowing a shared secret (much as password resets operate in the existing art), or require the user to use an out-of-band communication (e.g. a verification link transmitted to the user through email) that is directed to an account uniquely associated with the user.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of authenticating a user at a relying party, the method comprising:
receiving a set of credentials;
using a validation processor to execute stored instructions to validate each credential in the set of credentials;
using a processor to execute stored instructions to determine that the set of credentials is associated with an existing user account; and
authenticating the user as having access to the existing user account.

2. The method of claim 1 wherein the step of receiving the set of credentials includes receiving the set of credentials from the user over a data network.

3. The method of claim 1 wherein the step of receiving the set of credentials include receiving the set of credentials from an identity agent on behalf of the user over a data network.

4. The method of claim 1 wherein the set of credentials includes a primary identifier and a set of associated universal resource identifier based identifiers.

5. The method of claim 4 wherein the primary identifier includes a public portion of an authentication challenge.

6. The method of claim 5 wherein the public portion includes the public key from a public-private encryption key pair.

7. The method of claim 6 wherein the step of using the processor to execute stored instructions to determine that the set of credentials is associated with an existing user account includes:
receiving a verification element associated with the received set of credentials; and
determining that the verification element was generated using a private portion of the authentication challenge.

8. The method of claim 6 wherein the primary identifier further includes a signature block generated with the private key.

9. The method of claim 5 wherein the primary identifier includes a verification universal resource locator.

10. The method of claim 9 wherein the primary identifier includes a signature block that can be verified using the verification universal resource locator.

11. The method of claim 4 each identifier in the set of associated universal resource identifier based identifiers resolves to a unique identifier document.

12. The method of claim 11 wherein each unique identifier document includes the primary identifier and references the universal resource identifier based identifiers in the set not associated with the identifier document.

13. The method of claim 12 wherein the step of using a validation processor includes:
retrieving the unique identifier document associated with each identifier in the set of universal resource identifier based identifiers; and
determining that each retrieved identifier document includes the primary identifier and references the universal resource identifier based identifiers in the set not associated with the identifier document.

14. The method of claim 1 wherein the step of authenticating the user includes determining that only a majority of the credentials in the set of credentials are associated with the user account.

15. The method of claim 14 further including the step of updating that set of credentials associated with the user account to include all the credentials in the set of credentials.

16. A relying party for authenticating a user, the relying party comprising:
a login processor for receiving a set of credentials;
a credential validation engine for receiving credentials from the set of credentials from the login processor, and for validating the received credentials; and
a user login database for storing credentials in association with a user account, and for transmitting user authentication verification to the login processor in response to receipt of validated credentials matching the stored credentials.

17. The relying party of claim 16 wherein the login processor includes means to update the user login database if a user account is associated with a majority of the credentials in the received set so that the user account is associated with all the credentials in the received set.

18. The relying party of claim 16 wherein the credential validation engine includes a cryptographic processor for determining that a verification element received in conjunction with the received set of credentials was generated by a private cryptographic key associated with a public cryptographic key contained in a Primary Identifier contained in the received set of credentials.

19. The relying party of claim 16 wherein the credential validation engine includes a verification service interface for issuing a validation request to a verification service specified in a primary identifier contained in the received set of credentials.

20. The relying party of claim 16 wherein the login processor includes means to retrieve identifier documents associated with universal resource identifier based identifiers contained in the received set of credentials.

21. The relying party of claim 20 wherein the validation engine includes means to determine that a retrieved identifier document includes a primary identifier matching a primary identifier contained in the received set of credentials and a listing of universal resource identifiers associated with universal resource identifier based identifiers not associated with the retrieved identifier document and contained in the received set of credentials.

22. An identity agent for managing user identity credentials for submission to a relying party, the agent comprising:
a credential database for storing the user identity credentials; and
an identity selection engine for receiving a credential request from the relying party, requesting a set of user identity credentials from the credential database associated with the relying party, and for transmitting to the relying party a set of credentials received from the credential database in response to the request.

23. The identity agent of claim 22 further including a login database for associating the relying party to at least one set of credentials in the credential database and for providing the identity selection engine with an indication of which credentials in the credential database are associated with the relying party.

24. The identity agent of claim 23 wherein the login database associates the relying party to more than one set of credentials and wherein the indication of which credentials are associated with the relying party includes indication that multiple sets of credentials are associated with the relying party, each set of credentials associated with a distinct persona.

25. The identity agent of claim 24 wherein the identity selection engine includes a user interface for providing the user with a list of personas associated with a relying party, and for obtaining persona selection information from the user, the identity selection engine for obtaining a set of credentials from the credential database selected in accordance with the obtained persona selection information.
